(19) United States
(12) Patent Application Publication
(10) Pub. No.: US 2004/0138986 A1
(43) Pub. Date: Jul. 15, 2004

(54) System and method for multi-channel retail auction

(76) Inventor: Adam Petrovich, Pittsburgh, PA (US)

Correspondence Address: Fay Kaplun & Marcin, LLP, 150 Broadway,, Suite 702, New York,, NY, 10038, US

(21) Appl. No.: 10/340,914

(22) Filed: Jan. 9, 2003

(51) Int. Cl. G06F 17/60

(52) U.S. Cl. 705/37

(57) ABSTRACT

Described are a system and method for conducting an auction. The system may include a plurality of mobile devices and a server. Each mobile device may include a data reading arrangement (e.g., a barcode reader) for reading from products product identifier data and a data transmission arrangement (e.g., a modem or a wireless modem) for transmitting product selection data including product identifier data read from a product, customer identifier data corresponding to a customer controlling the mobile device and desired transaction data (e.g., a price). The server communicates with a product database where the server stores the product selection data. For each selected product, the server compares product selection data received from the customers to determine, based on information stored in the product database, whether the product selection data received from one or more customers meets predetermined sale criteria.

### BACKGROUND INFORMATION

In a traditional retail store, products are typically offered at fixed prices. Users who are willing to pay the fixed prices, purchase the products at these prices. If the store cannot sell a product within a predefined period of time, such product is “marked down” (once or several times) over an extended time period until it is sold. Typically, after the markdown time period elapses, the products which the store cannot sell, are returned to a vendor/manufacturer or sent to a consolidation/clearance center. The administration, labor, handling of markdowns and clearance items are expensive to the retailer.

There are systems that provide the user with a mechanism to “bid” on markdown or clearance items in an open market or an auction. Such systems may work well in some cases where, for example, the product's price is a variable which may depend on user's buying preferences or on a perceived value of products.

One of such systems is an on-line auction that allows a user to buy a variety of products. The on-line auction may work well where the user knows exactly which product he wants to buy. For example, a user who wants to buy an item, may research the one or more products to learn about available features, price information, performance characteristics, expert opinions, etc. Once the user has decided on a particular product, he may utilize an on-line auction (e.g., e-Bay, Yahoo! Auctions, etc.) to purchase the product.

Such systems may work well for users willing to make decisions based solely on research data and/or who are willing to purchase products without physically looking at and/or touching them. However, for users who want to look and touch products before buying, the above-described systems may be inadequate. For example, before deciding which product to purchase, certain users may want to go to a local store to personally review the features of the player, consult with a salesperson, try the product, etc. Once the user is satisfied and has decided on a product he may purchase the player in the store without knowing whether he could have bought player for a better price using an on-line action. Alternatively, after examining the product in a store a user may try to buy the player in an on-line auction to obtain a lower price. Of course, this requires the user to find access to the Internet and locate an on-line auction which features the selected product. If the user is successful in the auction, he purchases the player.

The above-described systems may be even more inadequate for users searching for unique or hard-to-find items which are not easily identifiable by a model number, etc. In such cases, the user usually ends up buying the item either in a store without the price savings of an on-line auction or in an on-line auction without the benefit of a personal examination of the product.

### SUMMARY OF THE INVENTION

The present invention relates to a system and method for conducting an auction. The system may include a plurality of mobile devices and a server. Each mobile device may include a data reading arrangement (e.g., a barcode reader, an RFID interrogator, a magnetic strip scanner, etc.) for reading from products product-identifier data and a data transmission arrangement (e.g., a modem or a wireless modem) for transmitting product selection data including product identifier data read from a product, customer identifier data corresponding to a customer controlling the mobile device and desired transaction data (e.g., a price, quantity, etc.).

The server communicates with a product database where the server stores the product selection data. For each selected product, the server compares product selection data received from the customers to determine, based on information stored in the product database, whether the product selection data received from one or more customers meets predetermined sale criteria.

### BRIEF DESCRIPTION OF DRAWINGS

The accompanying drawings are included to provide a further understanding of the invention and are incorporated in and constitute part of the specification, illustrate several embodiments of the invention and, together with the description, serve to explain examples of the present invention. In the drawings:

FIG. 1 shows an exemplary embodiment of a system for a multi-channel retail auction according to the present invention; and

FIG. 2 shows an exemplary embodiment of a method according to the present invention.

### DETAILED DESCRIPTION

The present invention may be further understood with reference to the following description of preferred exemplary embodiments and the related appended drawings, wherein like elements are provided with the same reference numerals.

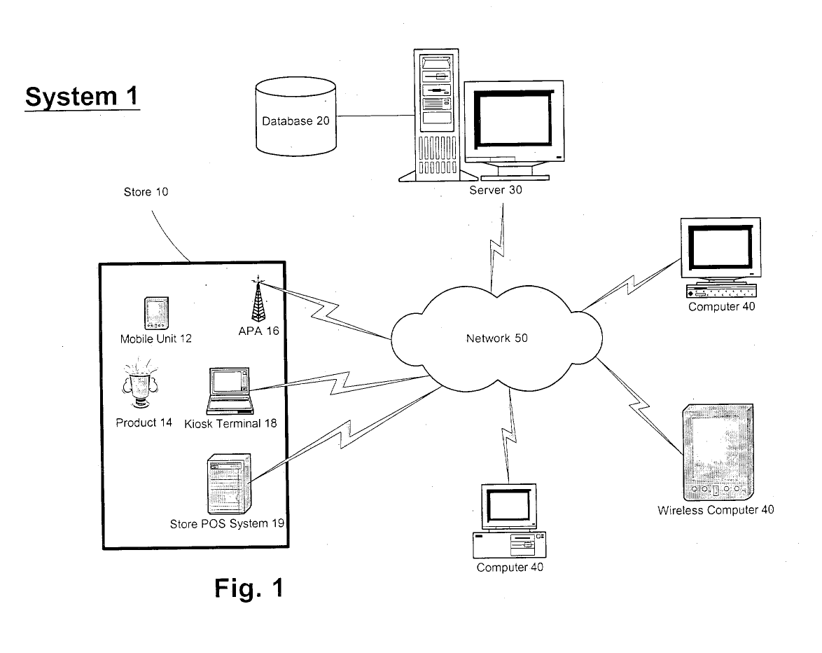

FIG. 1 shows an exemplary embodiment of a system 1 for a multi-channel retail auction (“MCRA”) according to the present invention. In particular, a retail store 10 offers a plurality of products to consumers. Such products may include regularly priced products and/or products that need to be sold by the store 10 relatively quickly (e.g., clearance items, seasonal merchandise, reconditioned items, etc.). In order to expedite sales of certain products, the store 10 may be only interested in marking down the price of such products to the highest price which will generate the desired sales and to determine this price level at the least possible costs. The store 10 may achieve these and other goals by implemented the system 1 according to the present invention.

The system 1, as illustrated in FIG. 1, may include a plurality of mobile units 12 which communicate with an Access Point Arrangement (“APA”) 16. The APA 16 may serve as an intermediary arrangement situated between the mobile units 12 and a server 30. In particular, the APA 16 and the server 30 may communicate via a communication network 50 (e.g., a local area network, the Internet, etc.). Alternatively, the APA 16 may be directly linked to the server 30. In alternative exemplary embodiment of the present invention, the mobile unit 12 may communicate with the server 30 in a “batch” type mode.

The mobile unit 12 may be, for example, a portable digital assistant (“PDA”), a handheld scanner, a keyfob scanner, a cell phone, etc. which is capable of reading encoded data such as bar codes. More specifically, an example of an mobile unit 12 is the Consumer Scanner CS1504 manufactured by Symbol Technologies (keyfob scanner). Such a mobile unit 12 may include a bar code scanner or other imager, a processor and a memory arrangement which allow the mobile unit 12 to read bar codes and store corresponding data. The mobile unit 12 may communicate with the APA 16 using any of conventional wired or wireless connections (e.g., IEEE 802.11b, Bluetooth, TCP/IP, USB, IEEE 1394, etc.) or a combination of both such connections. For example, the mobile unit 12 may communicate via a wireless WAN (e.g., a cellular phone or data network). The APA 16, for instance, may be an access point allowing a wireless communication with the mobile unit 12 or may be a personal computer (e.g., in-store computer or a kiosk computer 18) having a “docking port” (e.g., a USB port) to which the mobile unit 12 may be coupled.

The server 30 may be a conventional server which is connected to or including a database 20 data relevant to the store 10 and the products offered thereby and the system 1 in general. The server 30 is utilized to collect and process data and to manage communications among the various parts of the system 1.

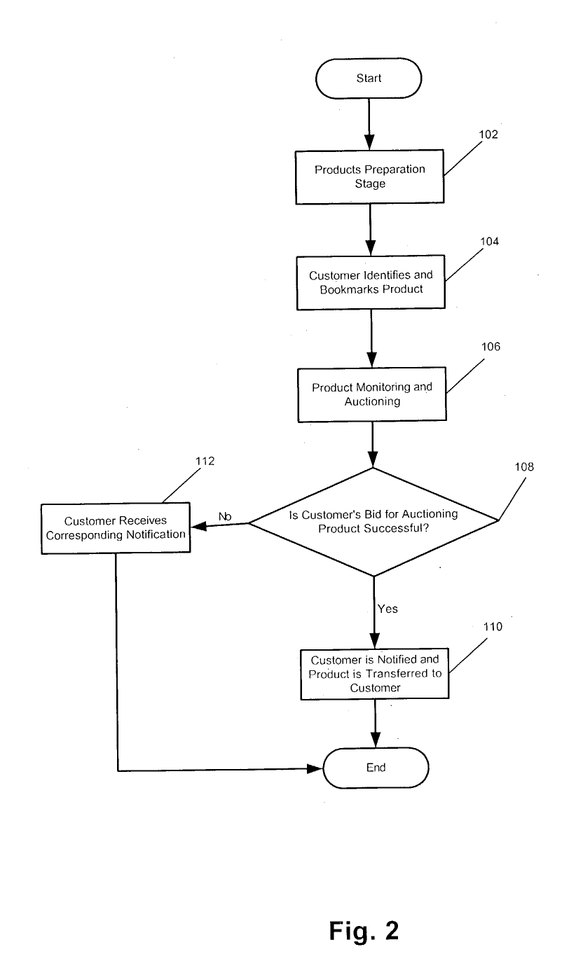

FIG. 2 shows an exemplary embodiment of a method according to the present invention. In step 102, a products preparation stage for the MCRA is performed by the store 10. In particular, the store 10 identifies products which will participate in the MCRA. For example, a product 14 is selected to participate in the MCRA. The product 14 is then correspondingly marked with, e.g., a tag. The tag may be in the form of a bar code and may include information indicating, e.g., that this product 14 participates in the MCRA, along with an initial price, a time frame for the MCRA, a unique identification number identifying the product 14, the store 10 and the system 1, etc. In addition, the information is transmitted to the server 30 and stored in the database 20. The store 10 may utilize a conventional handheld scanner (not shown) to enter data, scan bar code information, present bar codes and transmit information to the server 30. Alternatively, or in addition, the store 10 may utilize a conventional computer (not shown) including a scanner to perform functions similar to the functions described above.

Once the products preparation stage has been completed, customers in the store 10 are informed that they may participate in the MCRA. The store 10 provides interested customers with mobile units 12. Each mobile unit 12 is associated/registered with a corresponding customer. For example, a customer, who pre-registers with the store 10, maybe assigned a unique customer identification number (CIN) which is provided to the corresponding mobile unit 12. The customers may browse through the store 10 to look at the products sold in the store 10 as well as the products participate in the MCRA. A customer finding a participating product 14 that he would like to buy may bookmark the product 14 by, e.g., scanning the corresponding bar code using his mobile unit 12 (step 104). If a customer utilizes the mobile unit 12 which has interactive capabilities (e.g., using, RF, LAN or WAN) and has an ability to determine a customer's location in the store 10 (e.g., using GPS), the mobile unit 12 may notify the consumer of products that participate in the MCRA as the customer visits various locations or departments within the store 10.

The information from the bar code of the product 14 along with the CIN, is then transmitted via the APA 16 to the server 30 and is stored in the database 20. This step may be performed as soon as the mobile unit 12 receives the data or when the mobile unit 12 is connected to the APA (e.g., returns when the customer returns to the store 10.

In step 106, the customer monitors the MCRA for the particular product 14 in which he is interested. In particular, the customer may access this MCRA through the kiosk computer 18 situated in the store 10, or may remotely access the MCRA (e.g., from his residence or any other place which has access to the communication network 50) using a computer 40. In an alternative exemplary embodiment of the present invention, the mobile unit 12 may include various functionalities of the computer 40. In particular, the mobile unit 12 may be capable of scanning bar codes and displaying the progress of the auction on its screen while also allowing, the user to participate in the MCRA by making offers, etc. This allows the customer to monitor the MCRA as while browsing in the store 10 and, if the customer is successful in the auction, the customer may pick up the product before leaving the store 14.

By utilizing his CIN, the customer may easily find products 14 and corresponding MCRAs in which he has previously expressed an interest. The customer may monitor these MCRAs. Alternatively, or in addition, regular updates maybe automatically sent to interested customers (e.g., by email or via an interactive messaging system such as SMS). Customers may also be provided with a plurality of options including, for example, increasing or decreasing his bid for the product 14 or withdraw his bid for the product 14, etc. In addition, a customer may decide to add a particular product 14 to his “wish list” and bid for it later. Alternatively, a customer may conditionally withdraw from the auction, but request to be informed (e.g., via email), if the price for the product 14 falls below a predefined price, etc.

The server 30 performs the MCRA during a time frame specified by the store 10 and in accordance with predetermined rules which are may also be set by the store 10. Once the auction is closed, the server 30 identifies the successful bidder (step 108). For example, the highest bidder for the product 14 maybe entitled to purchase the product 14 at the accepted price. This customer may request that the product 14 be shipped to his residence or may pick up the product 14 in the store 10. All of these transactions may be completed by using the point of sale (“POS”) system 19 in the store 10. In addition, all the unsuccessful bidders may also be notified that their bid has not been accepted and that this MCRA is closed (step 112). Some products 14 may be sold to multiple customers at different prices.

This system provides a customer with a new shopping experience combining the excitement and cost-saving potential of an on-line auction is combined with the ambiance and experience of “a brick and mortar” retail store.

In addition, this system provides customers with a direct channel to clearance merchandise and, at the same time, provides cost saving benefits to the store 10 (e.g., drastically reducing the labor associated with multiple markdowns, handling, distribution center consolidation, selloffs to jobbers, etc.), while aiding the store in moving merchandise in a timely manner at the highest possible price.

As would be understood by those of skill in the art, this system is equally applicable to other sales systems including is expandable, e.g., reverse auctions to “push” out premium offers to customers, etc.

There are many modifications to the present invention which will be apparent to those skilled in the art without departing form the teaching of the present invention. The embodiments disclosed herein are for illustrative purposes only and are not intended to describe the bounds of the present invention which is to be limited only by the scope of the claims appended hereto.

What is claimed is:

1. A system for conducting an auction, comprising:
a plurality of mobile devices, each mobile device including a data reading arrangement for reading from products product identifier data and a data transmission arrangement for transmitting product selection data, the product selection data including product identifier data read from a product, customer identifier data corresponding to a customer controlling the mobile device and desired transaction data; and
a server communicating with a product database, the server receiving the product selection data and, for each selected product, comparing product selection data received from the customers to determine, based on information stored in the product database, whether the product selection data received from one or more customers meets predetermined sale criteria.

2. The system of claim 1, wherein the mobile device and the server communicate with each other via a communication network.

3. The system of claim 2, wherein the data transmission arrangement includes a wireless communication arrangement for a wireless access to the communication network.

4. The system of claim 3, further comprising:
a wireless access point arrangement (“APA”) connected to at least one of the server and the network, the APA being capable of establishing a wireless communication with the mobile device.

5. The system of claim 1, wherein the mobile device includes a location determination system which determines a location of the customer and wherein the server generates and forwards to the customer special offers relating to particular products participating in the auction and a location of the particular products.

6. The system of claim 5, wherein the location determination system is a global position system (“GPS”).

7. The system of claim 5, wherein the server selects the particular products based on the location of the customer.

8. The system of claim 1, wherein the data reading arrangement is one of a barcode scanner, an RFID interrogator, or a magnetic strip scanner and the product identifier data is stored in the form of a barcode, an RFID transponder, or a magnetic strip.

9. The system of claim 1, wherein the data reading arrangement is a barcode scanner, an RFID interrogator, a magnetic strip scanner and the product identifier data is stored in the form of a barcode, an RFID transponder, or a magnetic strip respectively.

10. The system of claim 1, further comprising:
a computing arrangement communicating with the server, the computing arrangement allowing the customer to obtain an access to the corresponding product selection data and a corresponding auction related data generated by the server.

11. The system of claim 8, wherein, using the computing arrangement, the customer manipulates and forwards to the server changes in the product selection data.

12. The system of claim 9, wherein the changes in the products selection data include at least one of changing a price which the customer wishes to pay for the selected product, changing a quantity of the selected product, withdrawing from the auction to buy the selected product.

13. The system of claim 1, wherein the predetermined sale criteria includes a price of the product, the server informing a particular customer whose corresponding product price for the selected product is the highest price, or a group of higher product prices for multiple products.

14. The system of claim 1, wherein the auction is performed for the products stored in a store.

15. The system of claim 12, further comprising:
a registering computer arrangement marking the product for participation in the auction and forwarding the corresponding product data to the product database, the computer arrangement generating a barcode including the product identifier data to be attached on the product.

16. The system of claim 12, wherein the computer arrangement communicates with the server using a wireless communication system.

17. The system of claim 1, wherein the desired transaction data includes a price that the customer wants to pay for the corresponding product.

18. A method of conducting an auction, comprising the steps of:
providing to a plurality of customers product scanning devices for reading and storing product identifier data from products;
receiving at a server selected product data along with desired transaction data from the corresponding customer, wherein the selected product data includes product identifier data from scanned products and customer identifier data from the product scanning devices;
accessing, based on the selected product data, information corresponding to the scanned products; and
comparing the received selected product and desired transaction data to the accessed information corresponding to the scanned products and to predetermined transaction data to determine whether the desired transaction data from one or more customers meets predetermined transaction criteria.

19. The method of claim 16, wherein the product scanning device and the server communicate with each other via a communication network, the device including a wireless communication arrangement for a wireless access to the communication network.

20. The method of claim 16, further comprising the steps of:
determining a location of the customer based on a location determination system of the product scanning device;
determining particular products which participate in the auction based on the location of the customer; and
forwarding to the product scanning device of the customer information about the particular products and a location of the particular products.

21. The method of claim 20, wherein the location determination system is a global position system (“GPS”).

22. The method of claim 16, wherein the product scanning device includes a barcode scanner, the method further comprising the step of:
reading a barcode using the barcode scanner to obtain the product identifier data.

23. The method of claim 16, further comprising the step of:
using a computing arrangement, providing an access for the customer to the server, the customer being capable of at least one of viewing and manipulating the desired transaction data.

24. The method of claim 16, wherein the predetermined transaction criteria includes a price of the product, the method further comprising the step of:
informing a particular customer whose corresponding product price for the selected product is the highest price.

25. The method of claim 16, wherein the auction is performed for the products stored in a store, the method further comprising the steps of:
selecting the products located in the store for participation of the auction;
generating a corresponding barcode including the product identifier data and attached the barcode onto the product; and
forwarding the product identifier data and corresponding store selection data to the server.

26. A device for conducting an auction, comprising:
an input/output (“I/O”) arrangement obtaining product selection data and customer identifier data corresponding to a customer controlling the scanning device;
a data reading arrangement reading product identifier data from products; and
a communicating arrangement transmitting selected product data including the product selection data, the product identifier data and the customer identifier data;
wherein the server accesses, based on the selected product data, information corresponding to the scanned products, the server comparing the received selected product and desired transaction data to the accessed information corresponding to the scanned products and to predetermined transaction data to determine whether the desired transaction data from one or more customers meets predetermined transaction criteria.
